(19) United States
(12) Patent Application Publication
(10) Pub. No.: US 2022/0244451 A1
(43) Pub. Date: Aug. 4, 2022

(54) OPTICAL PROPAGATION DEVICE

(71) Applicant: Adamant Namiki Precision Jewel Co., Ltd., Tokyo (JP)

(72) Inventor: Koji HORIGUCHI, Tokyo (JP)

(21) Appl. No.: 17/727,096

(22) Filed: Apr. 22, 2022

Related U.S. Application Data
(63) Continuation of application No. PCT/JP2020/040190, filed on Oct. 27, 2020.

(30) Foreign Application Priority Data
Oct. 28, 2019 (JP) 2019-194900

(51) Int. Cl. G02B 6/02

(52) U.S. Cl. CPC G02B 6/02

(57) ABSTRACT

Provided is an optical propagation device including an optical fiber having a core and a clad having a lower refractive index than a refractive index of the core, wherein the optical fiber is any of a step index multimode optical fiber or a few-mode optical fiber, an optical signal propagates in at least two or more multiple modes in the core of the optical fiber, the optical fiber is bent such that tensile force generated by bending is discontinuously applied to two or more locations of the optical fiber across a length direction of the optical fiber, and at each bent portion of the optical fiber, stress is non-uniformly generated across an outer peripheral direction of the optical fiber.

### CROSS-REFERENCE TO RELATED APPLICATION

The present application is a continuation application of International Application No. PCT/JP2020/040190, filed on Oct. 27, 2020, which claims priority to Japanese Patent Application No. 2019-194900, filed on Oct. 28, 2019. The contents of these applications are incorporated herein by reference in their entirety.

### BACKGROUND

### 1. Technical Field

One aspect of the present disclosure relates to an optical propagation device.

### 2. Related Art

With a continuous increase in the amount and type of multimedia information communication applications, a demand for a higher-speed Internet traffic has been growing, and study on an optical fiber communication link as a core technology has been actively conducted.

A receiver on the basis of coherent communication and electron digital signal processing has various compensation functions for transmission failure, such as flexibility, scalability, and optical fiber non-linearity. Thus, this receiver has been accepted as a next-generation standard for a long-distance communication system. Due to the optical fiber non-linearity, a realizable spectral efficiency is limited. For this reason, an optical fiber with a great effective cross-sectional area (Aeff) is designed so as to reduce a disadvantage due to the non-linearity.

However, in the method in which the effective cross-sectional area of the optical fiber is increased, improvement in the spectral efficiency of the optical fiber is limited. Thus, another solution is necessary for increasing a system capacity.

As an optical propagation device suitable for use of a mode-division multiplexing (MDM) optical transmission system, an optical fiber link is disclosed (see, e.g., JP-T-2015-515765). This optical fiber link has a first optical fiber. The first optical fiber has a core supporting propagation and transmission of an XLP-mode optical signal at a wavelength of 1550 nm. X is an integer of greater than 1 and equal to or less than 20. The first optical fiber has a positive group delay difference between an LP01 mode and an LP11 mode in a case where the wavelength is 1530 nm to 1570 nm.

The optical fiber link further has a second optical fiber. The second optical fiber includes a core for propagation and transmission of a YLP-mode optical signal at a wavelength of 1550 nm. Y is an integer of greater than 1 and equal to or less than 20. The second optical fiber has a negative group delay difference between an LP01 mode and an LP11 mode in a case where the wavelength is 1530 nm to 1570 nm.

Of these two optical fibers, one optical fiber has the positive group delay difference between the modes, and the other optical fiber has the negative group delay difference between the modes. Further, after the lengths of these optical fibers have been properly set, these optical fibers are connected to each other. In this manner, the optical fiber link configured to cancel out the inter-mode group delay differences of two optical fibers each other to compensate for these differences can be built.

### SUMMARY

An optical propagation device includes an optical fiber having a core and a clad having a lower refractive index than a refractive index of the core. The optical fiber is any of a step index multimode optical fiber or a few-mode optical fiber, and an optical signal propagates in at least two or more multiple modes in the core of the optical fiber. The optical fiber is bent such that tensile force generated by bending is discontinuously applied to two or more locations of the optical fiber across a length direction of the optical fiber. At each bent portion of the optical fiber, stress is non-uniformly generated across an outer peripheral direction of the optical fiber.

### BRIEF DESCRIPTION OF DRAWINGS

FIG. 1 shows a view for describing an optical propagation device according to the present embodiment;

FIG. 2 shows a view for describing that bent portions of an optical fiber of FIG. 1 are discontinuously formed across a length direction of the optical fiber;

FIG. 3 shows a perspective view schematically showing a step index multimode optical fiber included in the optical propagation device according to the present embodiment;

FIG. 4A shows a perspective view schematically showing a single-core few-mode optical fiber included in the optical propagation device according to the present embodiment, and FIG. 4B shows a perspective view schematically showing a multicore few-mode optical fiber included in the optical propagation device according to the present embodiment;

FIG. 5 shows an enlarged view of a bent portion of the step index multimode optical fiber included in the optical propagation device according to the present disclosure for describing a state in which tensile force is generated by bending;

FIG. 6A shows an enlarged view of a bent portion of the single-core few-mode optical fiber included in the optical propagation device according to the present embodiment for describing a state in which tensile force is generated by bending, and FIG. 6B shows an enlarged view of a bent portion of the multicore few-mode optical fiber included in the optical propagation device according to the present embodiment for describing a state in which tensile force is generated by bending;

FIG. 7 shows a view for describing the configuration of the optical propagation device according to the present embodiment;

FIG. 8 shows a view for describing the optical propagation device based on the configuration shown in FIG. 7;

FIG. 9 shows a view for describing an optical propagation device according to another embodiment;

FIG. 10 shows a view for describing an optical propagation device according to still another embodiment;

FIG. 11 shows an observation image of an eye pattern of an optical propagation device according to an example of the present disclosure before an optical fiber is bent;

FIG. 12 shows an observation image of the eye pattern of the optical propagation device according to the example of the present disclosure in a state in which the optical fiber is bent; and

FIG. 13 shows a graph showing frequency property measurement results for the optical propagation device according to the example of the present disclosure before and after bending of the optical fiber.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

However, in the optical fiber link of JP-T-2015-515765, the positive and negative group delay differences of the optical fibers are calculated and compensated. Thus, the constituent material of each optical fiber needs to correspond with the measurement value. Further, the length of each optical fiber necessary for compensation for the group delay difference needs to be derived by calculation, and each optical fiber needs to be formed with a high accuracy. That is, a precise tolerance of each optical fiber length is required. Thus, the material and each optical fiber length need to be controlled and managed with a high accuracy. This easily leads to an increase in a manufacturing cost. Further, production tolerance is directly linked to degradation of group delay difference compensation.

Further, for forming a single optical fiber link, at least two types of optical fibers having positive and negative group delay differences need to be prepared. This leads to an increase in a material cost. Moreover, the step of bringing the optical fibers into cascade connection is necessary. This leads to an increase in the manufacturing cost due to an increase in the number of steps.

One object of the present disclosure is to achieve an optical propagation device which can compensate for a group delay difference and can be formed at a reduced manufacturing cost.

An optical propagation device according to one aspect of the present disclosure (the present optical propagation device) includes an optical fiber having a core and a clad having a lower refractive index than a refractive index of the core. The optical fiber is any of a step index multimode optical fiber or a few-mode optical fiber, and an optical signal propagates in at least two or more multiple modes in the core of the optical fiber. The optical fiber is bent such that tensile force generated by bending is discontinuously applied to two or more locations of the optical fiber across a length direction of the optical fiber. At each bent portion of the optical fiber, stress is non-uniformly generated across an outer peripheral direction of the optical fiber.

In the present optical propagation device, the tensile force may be applied to the optical fiber by bending without the optical fiber being wound.

In the present optical propagation device, an even number of bent portions as said bent portion may be formed across the length direction of the optical fiber, and a number of the bent portions may be equal between opposite bending directions.

According to the present optical propagation device, a higher-order mode optical signal propagates relatively faster in multiple modes. Further, lower-order mode light propagates relatively slower. Thus, a group delay difference between the multiple modes is reduced (compensated), and also distortion of the optical signal between the multiple modes is reduced. Accordingly, an eye pattern is improved.

Moreover, the eye pattern can be improved with a simple structure, and the length of the optical fiber does not need to be controlled and managed with a high accuracy. Consequently, the manufacturing cost is reduced, and design, maintenance, and manufacturing are facilitated. With the simple structure, a high toughness is obtained. Further, any one type of a step index multimode optical fiber or a few-mode optical fiber is employed as the optical fiber, and therefore, multiple types of optical fibers do not need to be prepared. Thus, an increase in the material cost can be suppressed. In addition, the step of connecting the multiple types of optical fibers to each other is not necessary, and therefore, the manufacturing cost is reduced because the number of steps is reduced.

The present optical propagation device is configured such that the optical fiber is not wound. Thus, the optical fiber length targeted for control can be shortened because the optical fiber is not wound. As a result, the response of the optical propagation device can be speeded up as compared to that of an optical propagation device configured such that an optical fiber is wound. Further, a spatial volume corresponding to the diameter of the wound portion is not necessary, and therefore, the optical propagation device can be reduced in size.

The total of the bent portions is an even number of two or more, and the number of the bent portions is set equal between the opposite bending directions. With this configuration, unevenness in a difference in a propagation speed (a mode group speed) between particular modes across the optical fiber length targeted for control can be eliminated. Thus, occurrence of the difference in the propagation speed (the mode group speed) between the particular modes can be reduced, and therefore, the eye pattern can be further improved.

According to a first feature of the present embodiment, the optical propagation device includes the optical fiber having the core and the clad having the lower refractive index than the refractive index of the core. The optical fiber is any of the step index multimode optical fiber or the few-mode optical fiber, and the optical signal propagates in the at least two or more multiple modes in the core of the optical fiber. The optical fiber is bent such that the tensile force generated by bending is discontinuously applied to the two or more locations of the optical fiber across the length direction of the optical fiber. At each bent portion of the optical fiber, the stress is non-uniformly generated across the outer peripheral direction of the optical fiber.

According to this configuration, the higher-order mode optical signal propagates relatively faster in the multiple modes. Further, the lower-order mode light propagates relatively slower. Thus, the group delay difference between the multiple modes is reduced (compensated), and also the distortion of the optical signal between the multiple modes is reduced. Accordingly, the eye pattern is improved.

Moreover, the eye pattern can be improved with the simple structure, and the length of the optical fiber does not need to be controlled and managed with the high accuracy. Consequently, the manufacturing cost is reduced, and the design, maintenance, and manufacturing are facilitated. With the simple structure, the high toughness is obtained. Further, any one type of the step index multimode optical fiber or the few-mode optical fiber is employed as the optical fiber, and therefore, the multiple types of optical fibers do not need to be prepared. Thus, the increase in the material cost can be suppressed. In addition, the step of connecting the multiple types of optical fibers to each other is not necessary, and therefore, the manufacturing cost is reduced because the number of steps is reduced.

According to a second feature of the optical propagation device of the present embodiment, the tensile force is applied to the optical fiber by bending without the optical fiber being wound.

According to this configuration, the optical propagation device is configured such that the optical fiber is not wound. Thus, the optical fiber length targeted for control can be shortened because the optical fiber is not wound. As a result, the response of the optical propagation device can be speeded up as compared to that of the optical propagation device configured such that the optical fiber is wound. Further, the spatial volume corresponding to the diameter of the wound portion is not necessary, and therefore, the optical propagation device can be reduced in size.

According to a third feature of the optical propagation device of the present embodiment, the even number of bent portions are formed across the length direction of the optical fiber, and the number of the bent portions is equal between the opposite bending directions.

According to this configuration, unevenness in the difference in the propagation speed (the mode group speed) between the particular modes can be eliminated. Thus, occurrence of the difference in the propagation speed (the mode group speed) between the particular modes can be reduced, and therefore, the eye pattern can be further improved.

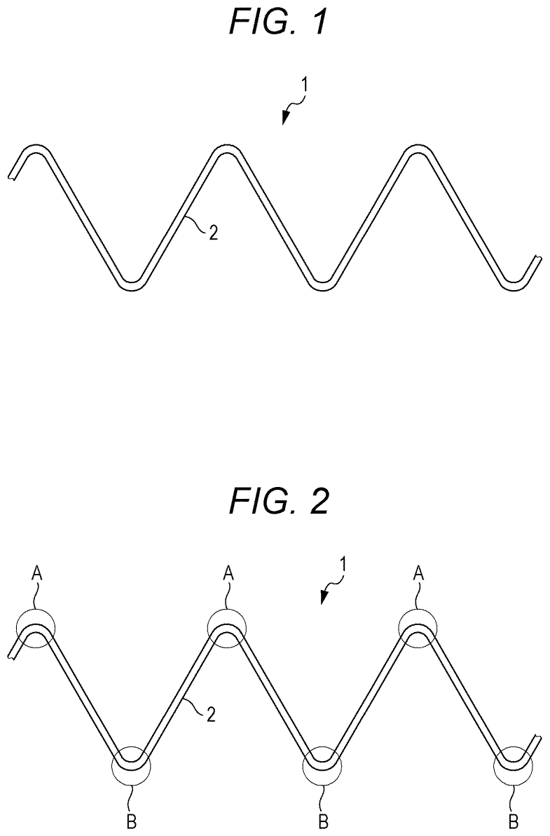

Hereinafter, the embodiment according to the present disclosure will be described with reference to FIGS. 1 to 10. As shown in FIG. 1, an optical propagation device 1 according to the present embodiment includes at least a single-type optical fiber 2.

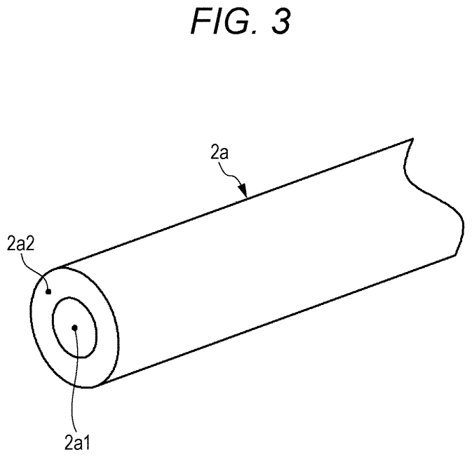

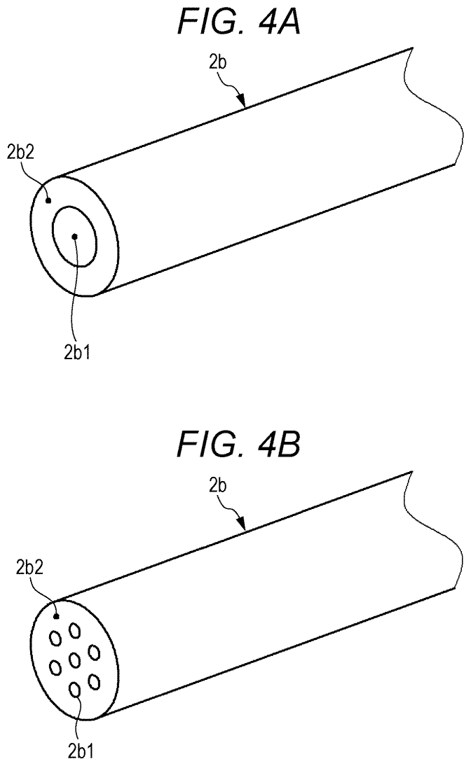

The optical fiber 2 has a core and a clad having a lower refractive index than the refractive index of the core. The type of the optical fiber 2 is any of a step index multimode optical fiber 2a shown in FIG. 3 or a few-mode optical fiber 2b shown in FIGS. 4A and 4B.

As shown in FIG. 3, the step index multimode optical fiber 2a has a single core 2a1 and a clad 2a2. The clad 2a2 is formed concentrically to surround the core 2a1, and has a lower refractive index than that of the core 2a1. The diameter of the core 2a1 is 50 μm to 62.5 μm, and the diameter of the clad 2a2 is 125 μm. Moreover, the material of the step index multimode optical fiber 2a includes quartz glass or fluoride glass.

On the other hand, the structure of the few-mode optical fiber includes two structures including a single-core structure (a single core 2b1) shown in FIG. 4A and a multicore structure shown in FIG. 4B. In the case of the single-core few-mode optical fiber, a clad 2b2 is formed concentrically to surround the core 2b1, and has a lower refractive index than that of the core 2b1.

The multicore few-mode optical fiber is configured such that multiple cores 2b1 are arranged inside the clad 2b2. The number of the cores is a plural number of two or more. For example, a few-mode optical fiber with a core number of 19 to 36 is available. FIG. 4B shows, as one example, an embodiment in which seven cores are arranged. Further, in the example shown in FIG. 4B, one of the multiple cores 2b1 is arranged at the center, and the remaining six cores are arrayed at equal angular intervals (60°) on a circumference.

The diameter of the core 2b1 of the few-mode optical fiber 2b shown in FIGS. 4A and 4B is about 10 μm to about 20 μm, and the diameter of the clad 2b2 is 80 μm to 300 μm. Moreover, the material of the few-mode optical fiber 2b includes quartz glass.

In the core (2a1 or 2b1) of the step index multimode optical fiber 2a or the few-mode optical fiber 2b as described above, an optical signal propagates in at least two or more multiple modes (multimode). In the case of the few-mode optical fiber 2b, the number of modes of each core 2b1 is 2 to 6 or less.

Further, in the optical fiber 2 as the step index multimode optical fiber 2a or the few-mode optical fiber 2b, non-uniform stress is generated across an optical fiber outer peripheral direction. As shown in FIGS. 1 and 2, such stress is generated inside the optical fiber 2 according to tensile force acting on the optical fiber 2 when the optical fiber 2 is bent. Bent portions of the optical fiber 2 are portions indicated by circles A and circles B in FIG. 2. Two or more bent portions are discontinuously provided across a length direction of the optical fiber 2 itself. Thus, the bent portions of the optical fiber 2 are intermittent, i.e., discontinuous, portions not across the entire length of the optical fiber 2 but across the length direction of the optical fiber 2. Note that the bent portions indicated by the circles A and the circles B may be provided at equal intervals or unequal intervals across the length direction of the optical fiber 2.

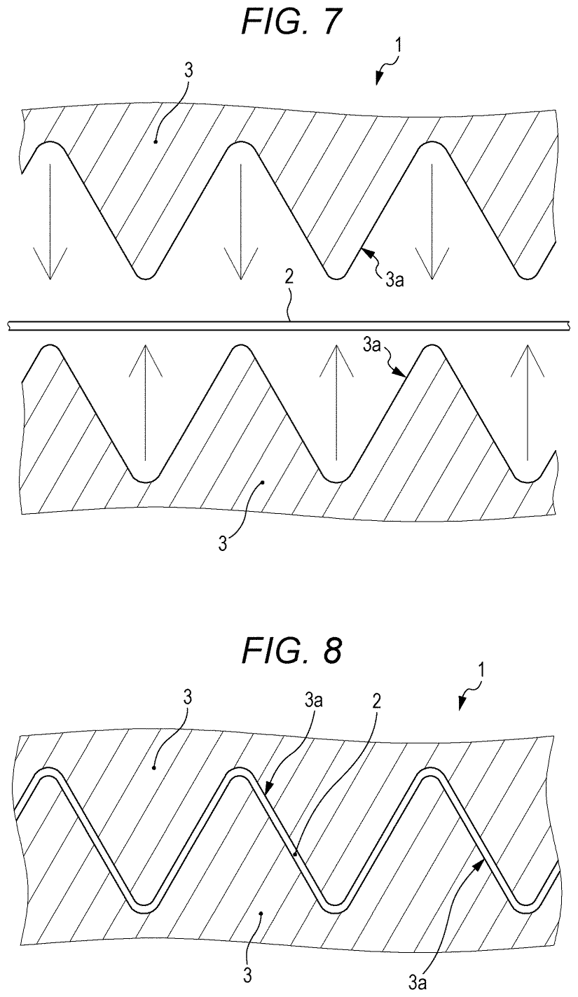

The method for forming the bent portions includes methods shown in FIGS. 7 to 10. FIGS. 7 and 8 show a method in which the bent portions are formed in such a manner that the optical fiber 2 is sandwiched using dies (3, 3). The dies are moved in an upper-lower direction as viewed in FIG. 7 as indicated by arrows, and accordingly, the optical fiber 2 is sandwiched between the dies (3, 3) in the upper-lower direction as in FIG. 8. At the dies (3, 3), a pair of contact surfaces 3a configured to contact the optical fiber 2 is formed. The shape of the contact surface 3a includes partial arcs and linear portions. The multiple bent portions are formed at once at the optical fiber 2 in such a manner that the optical fiber 2 is sandwiched by the partial arcs of the contact surfaces 3a in the upper-lower direction. Note that the dies (3, 3) are, for example, made of metal or rubber. The metal material includes, but not limited to, SUS304 as one example.

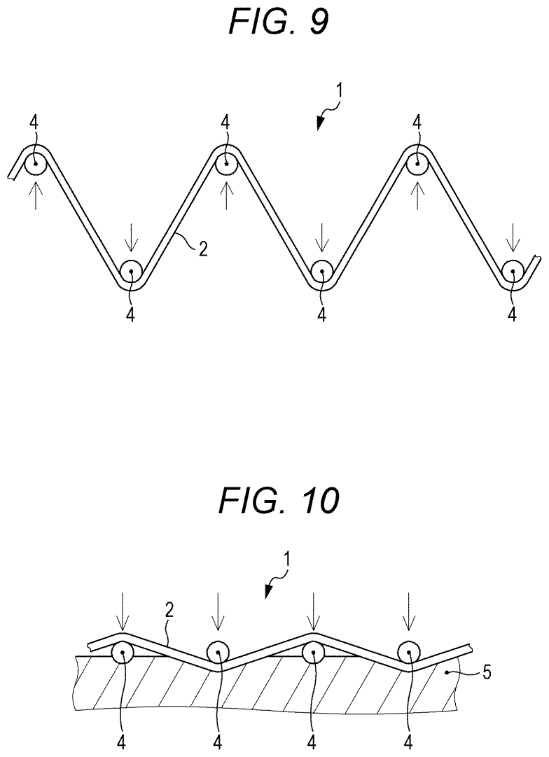

The method shown in FIG. 9 is a method in which the bent portions are formed using multiple circular columnar components 4. The circular columnar components 4 such as bobbins are moved in directions in an upper-lower direction as viewed in FIG. 9 as indicated by arrows such that adjacent ones of the circular columnar components 4 are separated from each other, and accordingly, the optical fiber 2 is, with pressure, pressed against a side surface of each circular columnar component 4. At such pressed portions, the optical fiber 2 is bent.

In the method shown in FIG. 10, the optical fiber 2 meanders to contact the multiple circular columnar components 4. Further, the optical fiber 2 is, together with the circular columnar components 4, pressed against surfaces of a rubber plate 5 in a direction indicated by arrows. Accordingly, the optical fiber is, with pressure, pressed against a side surface of each circular columnar component 4. At such pressed portions, the optical fiber 2 is bent. Note that the circular columnar components 4 shown in FIG. 9 or 10 are replaceable with cylindrical components. It may only be required that such a component is a component having a circular side surface.

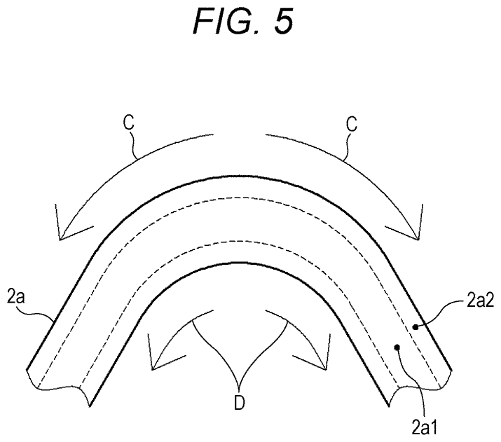

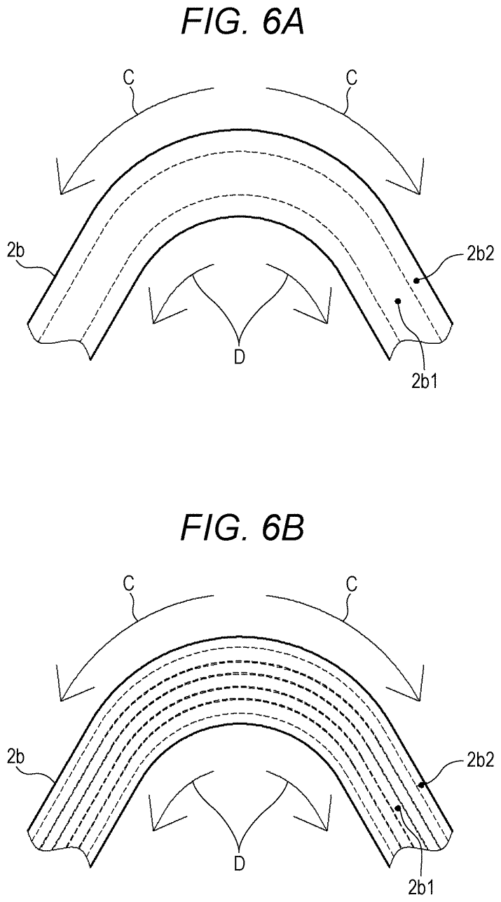

Enlarged views of the bent portion formed at the optical fiber 2 by the methods shown in FIGS. 7 to 10 are shown in FIGS. 5, 6A, and 6B. FIG. 5 is the enlarged view of the bent portion at the step index multimode optical fiber. On the other hand, FIG. 6A is the enlarged view of the bent portion at the single-core few-mode optical fiber. FIG. 6B is the enlarged view of the bent portion at the multicore few-mode optical fiber. Note that each of dashed lines in FIGS. 5, 6A, and 6B indicates a boundary between the core and the clad.

In both of the step index multimode optical fiber 2a and the few-mode optical fiber 2b, a greater tensile force is, upon bending, applied to the outside of the bent portion than to the inside of the bent portion. That is, in FIG. 5 and FIG. 6A or 6B, a relationship of tensile force C>tensile force D is established. Thus, a relatively-greater stress is generated at an outer peripheral portion, to which a greater tensile force C is applied, of the optical fiber (2a or 2b) on the outside. Further, a relatively-smaller stress is generated at an outer peripheral portion, to which a relatively-smaller tensile force D is applied, of the optical fiber (2a or 2b) on the inside. Thus, a magnitude relationship between the stress generated inside and the stress generated outside at the bent portion is established. Thus, the stress is non-uniformly generated across the outer peripheral direction of the optical fiber (2a or 2b) at the bent portion of the optical fiber (2a or 2b).

It has found that in the present embodiment, an eye pattern (an eye diagram) is improved in such a manner that non-uniform tensile force across the outer peripheral direction is discontinuously applied to two or more locations of the optical fiber 2. The principle thereof is as follows. That is, the optical fiber 2 is bent such that tensile force generated by bending is discontinuously applied to two or more multiple locations of the optical fiber 2 across the length direction, and in this manner, a higher-order mode optical signal propagates relatively faster in multiple modes. Further, lower-order mode light propagates relatively slower. This principle has been found by the applicant of the present application. Thus, a group delay difference between the multiple modes is reduced (compensated), and also distortion of the optical signal between the multiple modes is reduced. Accordingly, the eye pattern is improved.

The curvature radius of the bent portion of the optical fiber (2a or 2b) is set to such a range that a higher-order mode optical signal does not leak from the clad (2a2 or 2b2). Further, the bending angle of the optical fiber (2a or 2b) at each bent portion is set to less than 90° for preventing damage of the optical fiber (2a or 2b). In addition, the tensile force C, D is set to such an extent that damage of the optical fiber (2a or 2b) is not caused.

Further, the optical propagation device 1 is formed in such a manner that the optical fiber 2 is bent such that the tensile force generated by bending is discontinuously applied to two or more multiple locations of the optical fiber 2. Thus, in the optical propagation device 1, the eye pattern can be improved with a simple structure, and the length of the optical fiber 2 does not need to be controlled and managed with a high accuracy. Consequently, a manufacturing cost is reduced, and design, maintenance, and manufacturing are facilitated. With the simple structure, a high toughness is obtained. Further, any one type of the step index multimode optical fiber 2a or the few-mode optical fiber 2b is employed as the optical fiber 2, and therefore, multiple types of optical fibers do not need to be prepared. Thus, an increase in a material cost can be suppressed. Moreover, the step of connecting the multiple types of optical fibers to each other is not necessary, and therefore, the manufacturing cost is reduced because the number of steps is reduced.

Note that in any of the methods shown in FIGS. 7 to 10, another tensile load is preferably applied to the optical fiber 2 in advance in a right-left direction as viewed in the figure before application of the tensile force C, D. With the tensile load applied to the optical fiber 2 in advance, a desired stress which can improve the eye pattern can be generated at the optical fiber 2 by a small amount of tensile force C, D. Thus, the tensile force C, D to be applied to the optical fiber (2a or 2b) can be reduced, and damage of the optical fiber (2a or 2b) can be reduced. Specifically, the moving distance of the circular columnar component 4 shown in FIG. 9 in the upper-lower direction can be reduced, and the optical propagation device 1 can be compactly formed. Thus, the tensile load is preferably applied to the optical fiber 2 as described above.

More preferably, an even number of bent portions are formed across the length direction of the optical fiber 2, and the number of bent portions is equal between the opposite bending directions. The optical fiber 2 is bent such that the bent portion is raised upwardly at the location indicated by the circle A in FIG. 2 and is raised downwardly at the location indicated by the circle B in FIG. 2. Thus, an outer peripheral portion of the optical fiber 2 positioned outside at the location indicated by the circle A is positioned inside at the location indicated by the circle B. Thus, it can be said that the bending direction is opposite between the location indicated by the circle A and the location indicated by the circle B. Further, in FIG. 2, three bent portions are formed at the locations indicated by the circles A and three bent portions are formed at the locations indicated by the circles B, and the total of the circles A and the circles B is set to an even number of six. That is, it can be said that the total of the circles A and the circles B is an even number and a relationship of the number of locations indicated by the circles A=the number of locations indicated by the circles B is established in FIG. 2. It is obvious from each figure that similar configuration and relationship also apply to the methods shown in FIGS. 8 to 10.

The total of the bent portions formed across an optical fiber length which is a bent portion formation section and is targeted for control is an even number of two or more, and the number of bent portions is set equal between the opposite bending directions. With this configuration, unevenness in a difference in a propagation speed (a mode group speed) between particular modes across the optical fiber length targeted for control can be eliminated. Thus, occurrence of the difference in the propagation speed (the mode group speed) between the particular modes can be reduced, and therefore, the eye pattern can be further improved.

The optical fiber 2 of the optical propagation device 1 is not wound, but the optical fiber 2 is bent such that the tensile force generated by bending is applied to the optical fiber 2. That is, in the present embodiment, the optical fiber 2 is not wound. In a case where the optical fiber 2 is twisted to form a winding portion, the optical fiber 2 is wound around, e.g., a bobbin, or a circular ring portion is formed by the optical fiber 2, the optical fiber 2 needs to be wound by an amount corresponding to the optical fiber length. For this reason, there is a limitation on speed-up of an optical propagation device response.

On the other hand, the optical propagation device 1 is configured such that the optical fiber 2 is not wound. Thus, the optical fiber length targeted for control can be shortened because the optical fiber 2 is not wound. As a result, the response of the optical propagation device 1 can be speeded up as compared to that of an optical propagation device configured such that an optical fiber is wound. Further, a spatial volume corresponding to the diameter of the wound portion is not necessary, and therefore, the optical propagation device 1 can be reduced in size.

Note that if the optical fiber length portion is wound, the optical fiber length portion is uniformly bent with a certain curvature radius. For this reason, it is difficult to discontinuously apply the tensile force to the optical fiber across the optical fiber length.

Use application of the optical propagation device 1 includes a network or a datacenter for installation on a moving object such as an automobile, a train, or an airplane.

A graded index optical fiber is excluded from the present embodiment. This is because if an optical propagation device including the graded index optical fiber is used for an optical transmission system, there is a concern that a propagation loss or a coupling loss is caused and an eye pattern is degraded due to such a loss.

### Example

Hereinafter, an example of the present disclosure will be described. Note that the technique of the present disclosure is not limited only to the following example. The same numbers are used to represent elements overlapping with those of the optical propagation device 1 of the embodiment, and these elements will not be described or will be briefly described.

An optical propagation device according to the present example includes a single (quartz-based) step index multimode optical fiber 2a shown in FIG. 3. In this optical propagation device, the optical fiber 2a is bent at six locations in total in such a manner that the optical fiber 2a is, in an upper-lower direction, sandwiched by the pair of rubber dies (3, 3) shown in FIGS. 7 and 8.

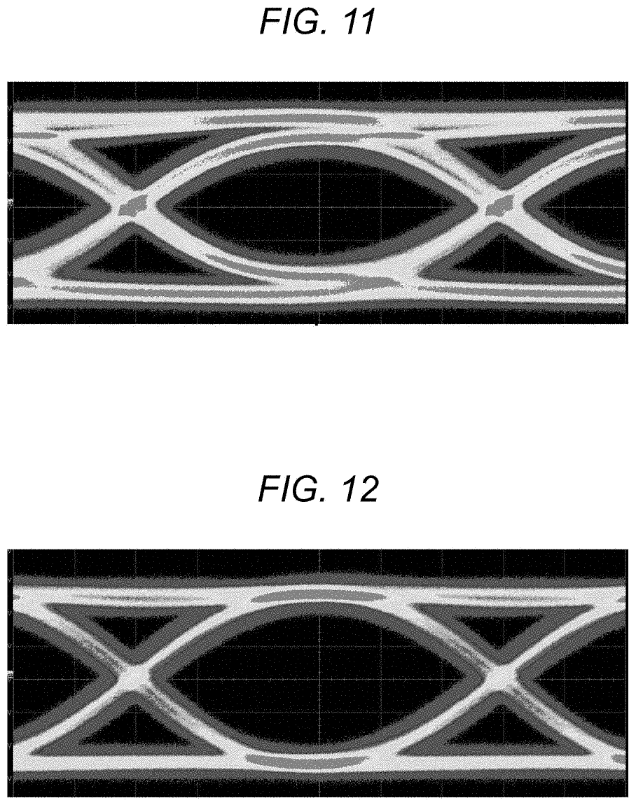

FIG. 11 shows an observation image of an eye pattern in the state (i.e., the state of FIG. 7) of the optical propagation device of the example before the optical fiber 2a is bent. On the other hand, FIG. 12 shows an observation image of an eye pattern in a state (i.e., the state of FIG. 8) in which the optical fiber 2a is bent.

Comparison between FIGS. 11 and 12 shows that the eye pattern of FIG. 12 is improved in terms of properties such as an opening height, a rise time, a fall time, and jitter. Thus, it has found that a group delay difference between multiple modes is reduced (compensated) as compared to a state in which no tensile force is applied by bending because the optical fiber 2a is bent such that tensile force generated by bending is discontinuously applied to the total of six locations of the optical fiber 2a across a length direction of the optical fiber 2a.

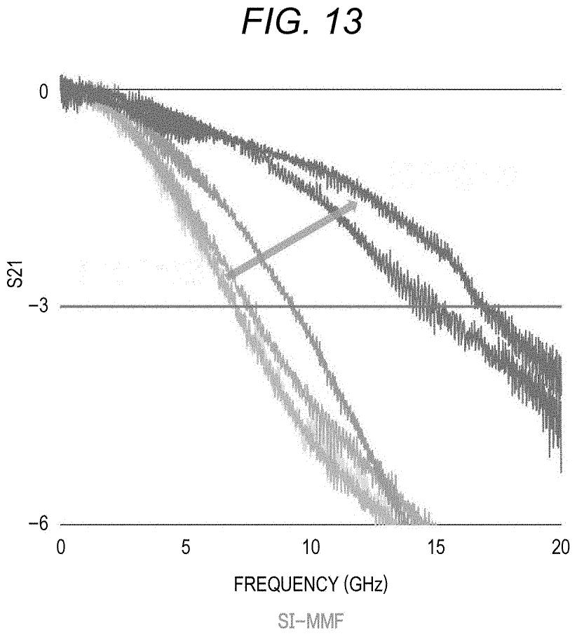

Further, FIG. 13 also shows that transmission properties in the optical fiber 2a are shifted to a higher frequency side and frequency properties are improved because the optical fiber 2a is bent.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. An optical propagation device comprising:
an optical fiber having a core and a clad having a lower refractive index than a refractive index of the core,
wherein the optical fiber is any of a step index multimode optical fiber or a few-mode optical fiber,
an optical signal propagates in at least two or more multiple modes in the core of the optical fiber,
the optical fiber is bent such that tensile force generated by bending is discontinuously applied to two or more locations of the optical fiber across a length direction of the optical fiber, and
at each bent portion of the optical fiber, stress is non-uniformly generated across an outer peripheral direction of the optical fiber.

2. The optical propagation device according to claim 1, wherein
the tensile force is applied to the optical fiber by bending without the optical fiber being wound.

3. The optical propagation device according to claim 1, wherein
an even number of bent portions as said bent portion are formed across the length direction of the optical fiber, and a number of the bent portions is equal between opposite bending directions.

4. The optical propagation device according to claim 2, wherein
an even number of bent portions as said bent portion are formed across the length direction of the optical fiber, and a number of the bent portions is equal between opposite bending directions.
